(19) United States
(12) Patent Application Publication
(10) Pub. No.: US 2026/0341176 A1
(43) Pub. Date: Oct. 29, 2026

(54) TEACHING METHOD AND GUIDES TO TEACH PIANO

(71) Applicant: Mher YESAYAN, Montreal (CA)

(72) Inventor: Mher YESAYAN, Montreal (CA)

(21) Appl. No.: 19/111,558

(22) PCT Filed: Sep. 14, 2023
(86) PCT No.: PCT/CA2023/000024

§ 371 Date: Mar. 13, 2025

(30) Foreign Application Priority Data
Sep. 14, 2022 (CA) 3174006

(51) Int. Cl. G09B 15/00; G10G 1/02

(52) U.S. Cl. CPC G09B 15/006; G10G 1/02

(57) ABSTRACT

A method and guide for piano players in the form of a long paper strip displaying a pattern of colored dots depicting a visual representation of the harmonized major scale which can be placed along the keys of a keyboard instrument and slid sideways to outline chords in any of the twelve tonal centers.

### FIELD OF THE INVENTION

This invention relates to a method of teaching piano by the use of guides created by a template, and the template for creating such guides.

### BACKGROUND OF THE INVENTION

It takes years of practice to internalize the interval patterns of chords and scales across all keys on keyboard instruments. It takes time to imbibe the core ideas of music theory; notes, intervals, octaves, scales, chords, and their relationships to one another. Keyboard players spend years practicing scales across all keys to hardwire those patterns in their fingers. Playing unintended notes is very common in the beginning, as it takes time to get familiar and comfortable with these patterns.

Different inventions have already helped musicians interpret key concepts of music theory visually, such as U.S. Pat. No. 2005/0016359A1 , which displays a strip of paper with numbered lines outlining the major scale, which can be placed upon a keyboard to help the player identify visually which notes are contained within a given major scale. The strip of paper can then be slid around from left to right to change keys. Although it is helpful to have an intervallic pattern of a major scale laid out on a paper strip placed along the keys of a keyboard to indicate which notes are in the scale, it only helps the user play melodies, as it provides no indication for the construction of triads and it does not allow the user to visually identify the patterns of diatonic chords derived from the major scale.

U.S. Pat. No. 2004/0231491 A1 is a plastic template with slots designed to help the user outline the intervallic pattern of his chosen chord or scale by marking a sheet of paper through any of the 13 slots provided. Once the paper is aligned with a keyboard, the given pattern highlights which notes are within the chord or scale, and the pattern can be slid around the keyboard from left to right to change keys. The trouble with this invention is that it helps you internalize all the concepts and chord types you need, but only one at a time, and not how they all interact with each other. If the user learns to play a diminished chord across the keyboard and to internalize that pattern through sheer repetition, it still does not help the user understand what purpose it serves within a diatonic chord progression.

U.S. Pat. No. 3,678,796 shows a device that can be described as a long ruler which displays a piano keyboard spanning a few octaves on the left side and a great staff adapted to align with those notes on the right side. Transparent slides featuring different scales and chord structures can be placed upon the device to highlight and link the piano keys they correspond to on the left and the staff notes on the right. A slide outlining the structures of the I, IV and V chords in their root positions covering one octave can be placed on the device and slid around to highlight the notes they correspond to in any given scale. This device does not help the user put the theory it presents into practice, because the user is left with the task of re-locating a given structure on an actual keyboard, and not on a simulacrum of one. It also presents the musical structures, such as major chords, minor chords or scales of any kind in isolated iterations, which prevents the player from deepening his understanding of the theory by seeing how these ideas actually might interact with each other within a given scale or key. The I IV V progression it outlines only provides three of the seven basic triads from the major scale, it outlines only the root positions of those chords in a single octave and it cannot be placed or interacted with on a real keyboard.

U.S. Pat. No. 6,284,961B1 , describes a system which assigns a color to each of the twelve notes and provides colored stickers to be placed on the keys of a keyboard, as well as printed sheet music with colored notes to help the player relate the key being pressed to the colored note displayed on the sheet music Associating each of the twelve notes with a single color might help you locate yourself quicker across a keyboard if the user is not familiar with that interface, but it does not teach the user any of the fundamental concepts of music theory that are actually important, namely the intervallic pattern of the major scale and the seven triads derived from it. It is easy to forget that those patterns are fixed and do not change based on which key a song is being played in. Although it might help to have a way of locating the next note to play in a given piece more easily if the colored stickers on the keys match the colored notes on the sheet music, it does not deepen our understanding of the core ideas of music theory.

U.S. Pat. No. 7,148,414 B2 provides a method for scanning, colorizing and printing sheet music. The method assigns each of the seven natural tones of an octave a specific color to help the player identify notes quicker. The invention also provides a set of colored stickers to be placed on top of the keys of a piano or keyboard instrument to match the colored notes of the sheet music. This does not help the user grasp an interactive understanding of scales or triad construction, and is only marginally helpful in learning to play a piece of written music.

U.S. Pat. No. 2010/0212477 A1 presents a set of guides that can be placed on top of a piano roll to outline a variety of major and minor scales and the correct fingering sequences for them. Although it is an interesting and useful idea for a novice player to have visual cues helping him identify which fingers to use when practicing scales, it provides no information about the triads derived from that scale.

### SUMMARY OF THE INVENTION

According to one embodiment of the invention, there is provided a template comprising a long and narrow strip of paper displaying a repeating pattern of seven different colored dots arranged vertically in groups of three. Each color corresponds to one of the seven basic triads derived from the major scale. Each column of three colored dots represents a note in the major scale. The strip of paper is placed along the keys of a keyboard instrument. Each color invites the player to press any of the three notes within a given triad by associating it to a single color. This simplifies the process of playing diatonic chord progressions by helping the player locate the appropriate chord to play visually, and not through rote memorization.

One advantage of this strip is to enable anyone to play diatonic melodies, but more importantly diatonic chord progressions in any key by following seven colors, each associated with one of the seven basic triads derived from the major scale. In contrast to the long and tedious process of rote memorization, this invites an active and instinctive interaction with a limited set of visual cues made to guide the placement of fingers to the correct positions for the various voicings of the seven basic triads. This enables anyone to approach a keyboard and interact with the core structure of music theory (intervals, scales, chords and chord progressions) without needing to grasp all these concepts immediately. This relaxes the student, reducing the stress or discomfort of playing wrong notes by guiding the player with visual cues, instead of relying entirely on short term memory. Scales and chord structures are conceptual, so it is very useful to be able to visualize them, to be able to see the core patterns of music theory laid out visually on a keyboard interface. This method invites novice players to interact in a much more playful fashion by following a limited set of colors that represent each of the seven basic triads. Through sheer practice, most of the patterns can be recalled later without the guide, since the player who has practiced enough has internalized these patterns through sheer repetition.

The pattern displayed on the strip of paper makes it easy to play chord progressions nearly instantly by following a sequence of colors, each associated with one of the seven basic triads.

The user can discern that each scale degree has three different functions within three of the seven triads, and the user can quickly place their fingers to play any voicing they choose of any of those chords by selecting the keys under a given color. This strip of colored dots can then be shifted from left to right so it highlights the notes of the triads of any key we choose, since the equidistant nature of the keys on a keyboard instrument allows the user to keep the same exact pattern without having to modify anything about it.

This invention does not require any knowledge of how to read sheet music, and yet it displays the relationship between the diatonic chords and the notes they share, as well as the static nature of the pattern of triads derived from the major scale visually. A lot of the traditional conventions of writing sheet music can be very confusing and needlessly complicated for beginners, as certain notions, notations and concepts demand to be memorized, though there is no apparent internal logic to them. A good example of this is simply how one names the 12 notes within an octave. On a keyboard, the fact that sharps and flats are of a different color and size than naturals seems to imply that an interval of a black key next to a white key is somehow different from an interval of two adjacent white keys.

Furthermore, the fact that the white keys outline the C major scale might lead a beginner to assume that it is a more fundamental or important key than the other 11, or that the principles that govern its organization are different than the ones governing the other tonalities.

From a mathematical point of view, all the notes are distributed equally. Although I understand that having 12 white keys representing each note repeated across a full keyboard would make it much more difficult to locate what exact key you're pressing, it would make more sense in a conceptual form, just as naming them from one to twelve would. The point is that these biases prevent us from understanding the simplicity of the core pattern of triad constructions derived from the major scale and how it stays static when transposing keys.

### BRIEF DESCRIPTION OF THE DRAWINGS

Embodiments of the invention will now be described with reference to the following drawings in which:

FIG. 1 is a one octave section of the strip of paper indicating the scale degrees and the intervals separating them according to the major scale pattern (WWHWWWH);

FIG. 2 is the same pattern as FIG. 1, but spread over two octaves;

FIG. 3 is the same pattern as FIG. 1, but spread over three octaves;

FIG. 4 showcases the pattern indicated in FIG. 1 with the added colored dots indicating which notes in the scale are a part of which of the seven basic triads, according to one embodiment of the invention;

FIG. 5 showcases the same pattern indicated in FIG. 4, but spread over two octaves;

FIG. 6 showcases the same pattern indicated in FIG. 4, but spread over three octaves;

FIG. 7 shows how the strip of paper placed accordingly on a keyboard outlines the notes and the chords in the key of C major;

FIG. 8 shows how sliding the strip of paper to the left by one note now outlines the notes and the chords in the key of B major;

FIG. 9 shows the pattern without the top row outlining the major scale and without the numbers in subscript inside the colored dots;

FIG. 10 shows what colors the patterns inside the dots refer to.

FIG. 11 shows the same as FIG. 4 with an additional dot outlining the major III chord.

FIG. 12 shows the same as in FIG. 4 with 6 additional visual cues common showcasing non-diatonic alternatives to the triads.

FIG. 13 shows the same as FIG. 4 which outlines the chords in the Aeolian mode (the natural minor mode), which is the 6^{th} mode of the major scale.

FIG. 14 shows the chord progression in ‘Hallelujah’ by Leonard Cohen in roman numerals.

FIG. 15 shows an alternate way of representing the pattern in FIG. 4 where each column of three colored dots is now represented as a single dot divided into three equal parts matching those same colors.

### DETAILED DESCRIPTION

The interface of a keyboard instrument has some implicit biases rooted in its display; by separating the black notes in 2 and 3 note groups to carve out the C major scale with the white keys, it seems to imply that the black and white notes are somehow fundamentally different from each other, that their intervals are perhaps not completely equidistant from a mathematical point of view. This is of course, not the case.

Every key center on a keyboard is equidistant with all the other keys, despite the white keys covering a larger surface area than the black ones. This allows us to create a fixed visual pattern of intervals that can simply be shifted from left to right. The structure of the major scale and the function of those scale degrees in the seven basic triads don't change, as they are fixed musical structures. The notes under which the pattern falls will change, but the pattern itself doesn't.

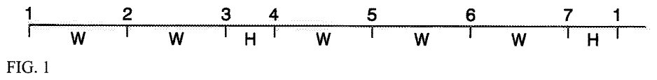

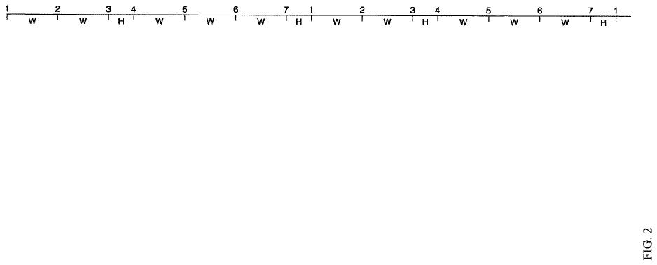

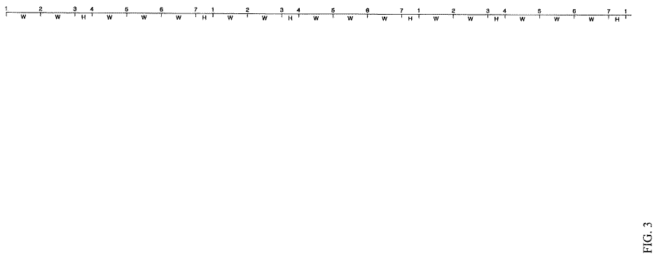

Referring to FIG. 1, to create the pattern, one starts by placing a blank strip of paper covering two full octaves along the keys of a keyboard instrument.

The strip of paper is aligned so both ends fall over the same note, two octaves apart (e.g. C3 to C5).

One outlines the intervallic pattern of the major scale (WWHWWWH) by writing the scale degrees aligned with our chosen key on the piece of paper (e.g. in the case of the C major scale, writing ‘1’ aligned with C3, writing ‘2’ aligned with D3, writing ‘3’ aligned with E3, etc.) One can now shift this pattern from left to right to change keys. The pattern outlines the major scale in any of the 12 keys, since the equidistant nature of the keys of a keyboard facilitates such a practice.

Thus far, this aligns with the prior art outlined in U.S. Pat. No. 2005/0016359 A1.

### The Guide

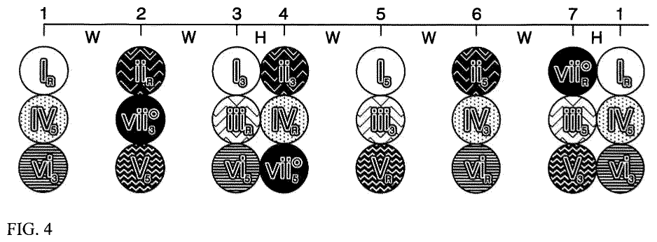

Referring to FIG. 4, the pattern indicated in FIG. 1 is showcased with the added colored dots indicating which notes in the scale are a part of which of the seven basic triads;

According to one embodiment of the invention, to create the pattern needed to fill in the triads derived from the major scale, each of the triads are a color
The three notes of the I chord are represented with red dots.
The three notes of the ii chord are represented with green dots.
The three notes of the iii chord are represented with light blue dots.
The three notes of the IV chord are represented with orange dots.
The three notes of the V chord are represented with yellow dots.
The three notes of the VI chord are represented with dark blue dots.
The three notes of the vii⁰ chord are represented with purple dots.

The first triad of the major scale is outlined. One starts by coloring a red dot with I_{R} inscribed in it right below the notation for the first scale degree. This dot indicates that this scale degree functions as the root of the I chord.

Following the pattern of triad construction, one skips the second scale degree and colors in a second red dot with I₃ inscribed in it right below the notation of the third scale degree. This dot indicates that this scale degree functions as the third of the I chord.

Next, one skips the fourth scale degree and colors in a third red dot with I₅ inscribed in it right below the notation of the fifth scale degree. This dot indicates that this scale degree functions as the fifth of the I chord.

The same process is repeated for the six remaining triads, associating each with a specific color.

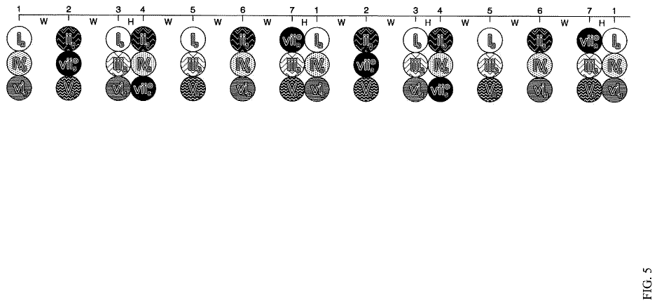

This pattern is duplicated for as many octaves as needed and the patterns are taped to each other so the repeating pattern covers the full range available to us. FIG. 5 showcases the same pattern indicated in FIG. 4 spread over two octaves. FIG. 6 showcases the same pattern indicated in FIG. 4 spread over three octaves;

Every column of three colored dots represents a note in the major scale. The white spaces between the columns of colored dots represent the notes that are not in the major scale.

The notation in subscript refers to the function of the note in its specific triad. R stands for root. 3 stands for third. 5 stands for fifth. The colors themselves are arbitrary and are only used to distinguish the chords from one another. Here, the major chords are represented with warm colors (red, orange and yellow) and the minor chords are represented with cold colors (green, light blue and dark blue). The diminished chord is represented in purple. One can now play chord progressions in every key by following the colors associated with each triad. The pattern does not change. To change keys, one simply drags the strip of dots across the keyboard to set a new root note.

The 1^{st} scale degree acts as the root of the I chord, the third of the vi chord and the fifth of the IV chord.

The 2^{nd} scale degree acts as the root of the ii chord, the third of the vii⁰ chord and the fifth of the V chord.

The 3^{rd} scale degree acts as the root of the iii chord, the third of the I chord and the fifth of the vi chord.

The 4^{th} scale degree acts as the root of the IV chord, the third of the ii chord and the fifth of the vii⁰ chord.

The 5^{th} scale degree acts as the root of the V chord, the third of the iii chord and the fifth of the I chord.

The 6^{th} scale degree acts as the root of the vi chord, the third of the IV chord and the fifth of the ii chord.

The 7^{th} scale degree acts as the root of the vii chord, the third of the V chord and the fifth of the iii chord.

### Method

In use, and as described above, the user takes the template which comprises a long and narrow strip of paper displaying a repeating pattern of seven different colored dots arranged vertically in groups of three. Each color corresponds to one of the seven basic triads derived from the major scale. Each column of three colored dots represents a note in the major scale. The strip of paper is placed along the keys of a keyboard instrument. Each color invites the player to press any of the three notes within a given triad by associating it to a single color. This simplifies the process of playing diatonic chord progressions by helping the player locate the appropriate chord to play visually, and not through rote memorization.

The user can play diatonic melodies, but more importantly diatonic chord progressions in any key by following seven colors, each associated with one of the seven basic triads derived from the major scale. In contrast to the long and tedious process of rote memorization, this invites an active and instinctive interaction with a limited set of visual cues made to guide the placement of fingers to the correct positions for the various voicings of the seven basic triads. This enables anyone to approach a keyboard and interact with the core structure of music theory (intervals, scales, chords and chord progressions) without needing to grasp all these concepts immediately. This relaxes the user, reducing the stress or discomfort of playing wrong notes by guiding the player with visual cues, instead of relying entirely on short term memory. Scales and chord structures are conceptual, so it is very useful to be able to visualize them, to be able to see the core patterns of music theory laid out visually on a keyboard interface. This method invites novice players to interact in a much more playful fashion by following a limited set of colors that represent each of the seven basic triads. Through sheer practice, most of the patterns can be recalled later without the guide, since the player who has practiced enough has internalized these patterns through sheer repetition.

The pattern displayed on the strip of paper makes it easy to play chord progressions nearly instantly by following a sequence of colors, each associated with one of the seven basic triads. The user can discern that each scale degree has three different functions within three of the seven triads, and they can quickly place their fingers to play any voicing they choose of any of those chords by selecting the keys adjacent to a given color. This strip of colored dots can then be shifted from left to right so it highlights the notes of the triads of any key we choose, since the equidistant nature of the keys on a keyboard instrument allows the user to keep the same exact pattern without having to modify anything about it.

This invention does not require any knowledge of how to read sheet music, and yet it displays the relationship between the diatonic chords and the notes they share, as well as the static nature of the pattern of triads derived from the major scale visually. A lot of the traditional conventions of writing sheet music can be very confusing and needlessly complicated for beginners, as certain notions, notations and concepts demand to be memorized, though there is no apparent internal logic to them. A good example of this is simply how one names the 12 notes within an octave. On a keyboard, the fact that sharps and flats are of a different color and size than naturals seems to imply that an interval of a black key next to a white key is somehow different from an interval of two adjacent white keys.

Furthermore, the fact that the white keys outline the C major scale might lead a beginner to assume that it is a more fundamental or important key than the other 11, or that the principals that govern its organization are different than the ones governing the other tonalities.

From a mathematical point of view, all the notes are distributed equally. Although I understand that having 12 white keys representing each note repeated across a full keyboard would make it much more difficult to locate what exact key you're pressing, it would make more sense in a conceptual form, just as naming them from one to twelve would. The point is that these biases prevent us from understanding the simplicity of the core pattern of triad constructions derived from the major scale and how it stays static when transposing keys.

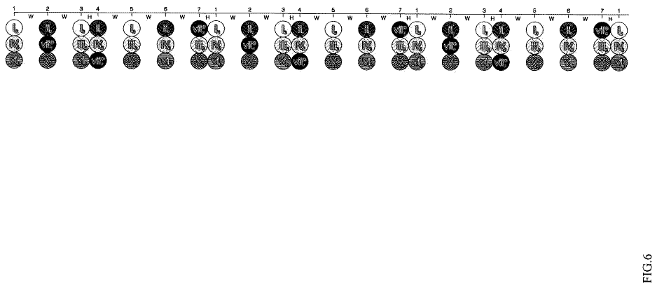

FIG. 7 shows how the strip of paper placed accordingly on a keyboard outlines the notes and the chords in the key of C major.

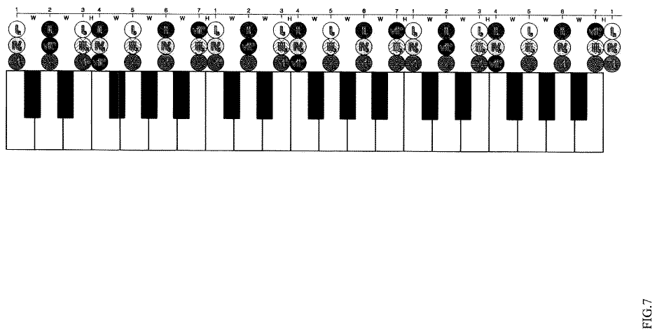

FIG. 8 shows how sliding the strip of paper to the left by one note now outlines the notes and the chords in the key of B major.

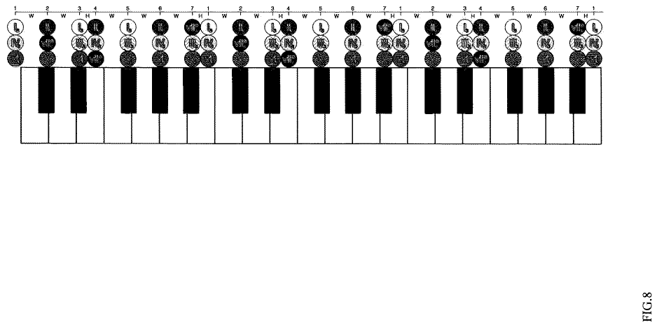

FIG. 9 shows the pattern without the top row outlining the major scale and without the numbers in subscript inside the colored dots.

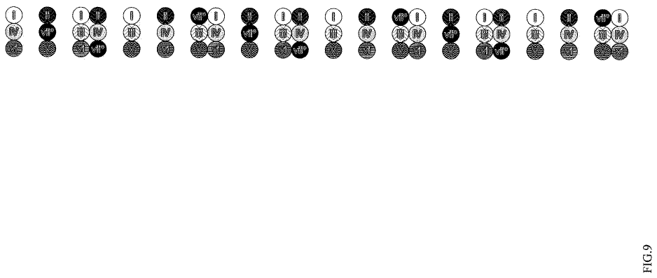

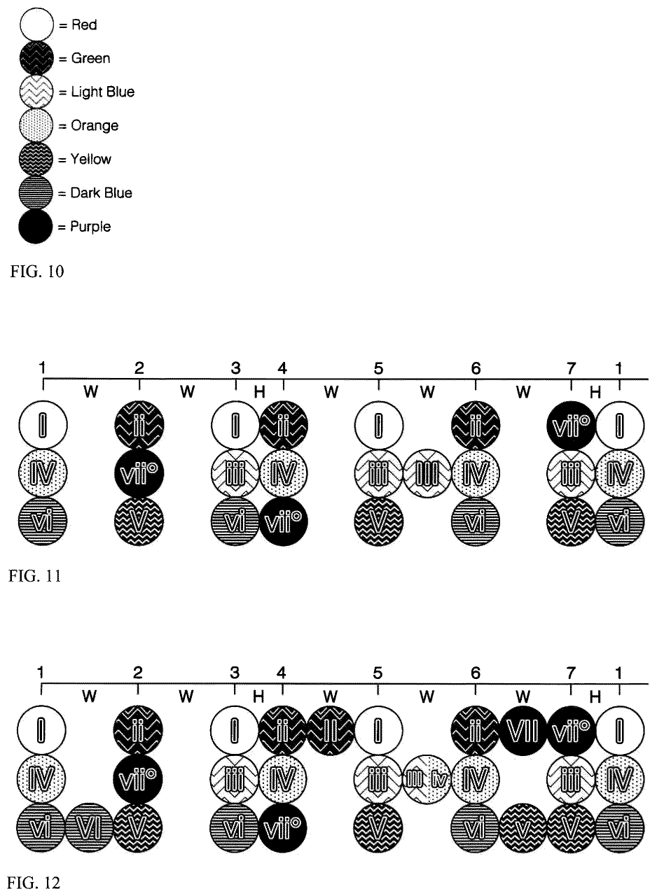

FIG. 10 shows what colors the patterns inside the dots refer to.

FIG. 11 displays the same pattern shown in FIG. 4 with one added dot. It shows that we can play the major alternative of the minor ‘iii’ chord, making its appropriate notation ‘III’ instead of ‘iii’. We play the root and the fifth of the ‘iii’ chord as usual, but we switch the minor third to a major third interval by playing the note that is a half-step above, outlined in the figure as the ‘III’ dot. Playing the ‘iii’ chord as major is a common occurrence in many pieces of music. It is notably found in the original version of ‘Hallelujah’ by Leonard Cohen. Additionally, going from the ‘III’ chord to the ‘vi’ chord in a major key is akin to going from the ‘V’ chord to the ‘i’ chord in its relative minor key.

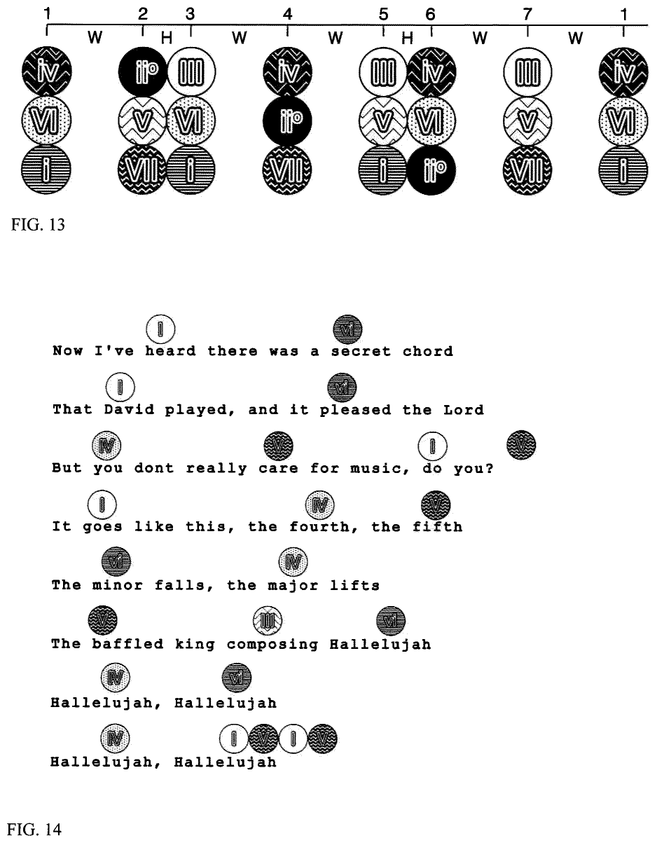

FIG. 12 displays another variation of the foundational pattern seen in FIG. 4, this time with six added alternatives to the 7 basic triads. It shows that we can play the ‘ii’ chord as major, the ‘iii’ chord as major, the ‘IV’ chord as minor, the ‘V’ chord as minor, the ‘vi’ chord as major and the ‘vii⁰’ chord as a flattened ‘VII’ major chord. This is a selection of some of the more common non-diatonic chords found in popular music in the past few decades. Though these are less common than the seven basic triads, they occur occasionally enough that the student should be aware of their different emotional resonances.
FIG. 13 is a variation of the initial pattern displayed in FIG. 4. It outlines the chords in the Aeolian mode (the natural minor mode), which is the 6^{th} mode of the major scale. We rearrange the pattern in FIG. 4 by picking the sixth scale degree as our new tonic, slicing the pattern in two chunks and tagging the first chunk after the second. The pattern of whole-steps and half-steps switches from WWHWWWH to WHWWHWW. We then change the value of the roman numerals inside the dots to match the Aeolian mode: ‘I’ becomes ‘III’, ‘ii’ becomes ‘iv’, ‘iii’ becomes ‘v’, ‘IV’ becomes ‘VI’, ‘V’ becomes ‘VII’, ‘vi’ becomes ‘i’, ‘vii⁰’ becomes ‘ii’.

The overall pattern is the same as in FIG. 4, but we have picked a new starting point: we changed the tonic from the 1^{st} to the 6^{th} scale degree of the major scale and renamed the chords accordingly.

FIG. 14 shows the chord progression in ‘Hallelujah’ by Leonard Cohen abstracted from a specific key. One way to play the chord progression on a piano or keyboard instrument would be to press any combination of three adjacent dots of the same color as the chords progress through the piece. The first step would be to press three adjacent red dots for the ‘I’ chord as the melody sings the word ‘heard’, then three adjacent dark blue dots for the ‘vi’ chord when the melody sings the word ‘secret’, and so on throughout the rest of the song. The strip of dots doesn't tell you exactly what voicing of a given chord to play. It simply outlines every note within that chord across the keyboard, making it an open ended tool. One can then explore playing the same progression in any key and in any register of the keyboard. Incidentally, this is an appropriate choice of song to demonstrate the strip of dots, as the lyrics ‘the fourth, the fifth’ reference the IV chord and the V chord played as those words are sung.

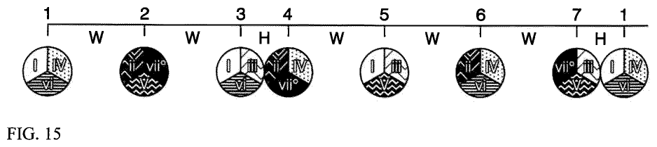

FIG. 15 shows an alternate way of representing the pattern in FIG. 4 where each column of three colored dots is now represented as a single dot divided into three equal parts matching those same colors. With the exception of the removal of the numbers in subscript, this new pattern still outlines the same information displayed in FIG. 4, but in a more compact visual format.

### DOWNLOAD INSTRUCTIONS FOR STUDENT

1. Measure (in millimeters) the length of an octave for your piano or keyboard instrument.
2. Download a corresponding pdf document of FIG. 4 that matches your measure length.
3. Count the number of octaves of your selected piano or keyboard instrument.
4. Print the document in colour. Make sure to select “actual size” when printing. Print enough copies of the document to cover one or more octave than the full range of your piano or keyboard instrument.
5. Cut the octave strips along the edges.
6. Tape the octave strips to each other while making sure the tonic overlaps with the next strip.
7. Repeat as needed for a full strip.

### HOW TO CREATE THE PATTERN

Step 1: Build root position triads for all seven scale degrees in the key of C Major.
1. Stick a red dot on each of the three notes of the I chord (C major): C3, E3, G3
2. Stick a green dot on each of the three notes of the ii chord (D minor): D3, F3, A3
3. Stick a light blue dot on each of the three notes of the iii chord (E minor): E3, G3, B3
4. Stick an orange dot on each of the three notes of the IV chord (F major):F3, A3, C4
5. Stick a yellow dot on each of the three notes of the V chord (G major): G3, B3, D4
6. Stick a dark blue dot on each of the three notes of the vi chord (A minor): A3, C4, E4
7. Stick a purple dot on each of the three notes of the vii⁰ chord (B diminished): B3, D4, F4
Step 2: Move the upper dots down an octave so that all 21 dots fit within a single octave.
1. For the IV chord, the orange dot on C4 goes down to C3.
2. For the V chord, the yellow dot on D4 goes down to D3.
3. For the vi chord, the dark blue dots go down from C4 to C 3 and from E 4 to E 3.
4. For the vii chord, the purple dots go down from D 4 to D 3 and from F 4 to F 3.
   We now see the following:
8 On C3, from the top down, we see a red dot, an orange dot and a dark blue dot.
On D3, from the top down, we see a green dot, a purple dot and a yellow dot.
On E3, from the top down, we see a red dot, a light blue dot and a dark blue dot.
On F3, from the top down, we see a green dot, an orange dot and a purple dot.
On G3, from the top down, we see a red dot, a light blue dot and a yellow dot.
On A3, from the top down, we see a green dot, an orange dot and a dark blue dot.
On B3, from the top down, we see a purple dot, a light blue dot and a yellow dot.
Step 3: Print this pattern of dots on a piece of paper.
Step 4: Print as many copies of the pattern as needed and tape them end to end to cover the full range of the desired keyboard instrument.

It will be understood that modifications could be made to the guide so that other shapes are used instead of dots or colours as long as the same pattern is reproduced.

The scope of the claims should not be limited by the preferred embodiments set forth in the examples, but should be given the broadest interpretation consistent with the description as a whole.

1. A guide for piano players to lead them in selecting piano keys to press, said guide comprising: displaying a pattern of colored dots depicting a visual representation of the harmonized major scale that is printed on a long strip of paper which can be placed along the keys of a keyboard instrument to outline chords of a given tonal center, and then additionally slid sideways to outline said chords in any of the twelve tonal centers.

2. The guide of claim 1, wherein notes of any chord are outlined across the keys of a keyboard instrument using dots of the same color.

3. The guide according to claim 1, wherein the colored dots can be shuffled vertically for a given column of three dots.

4. The guide according to claim 1, wherein each chord is represented by a different color.

5. The guide according to claim 1, wherein chord functions are inscribed as roman numerals within the colored dots.

6. The guide according to claim 1, wherein the roman numerals can be transposed to outline chord functions in different modes of the major scale.

7. The guide according to claim 1, further comprising additional colored dots to highlight alternate versions of a given chord.

8. The guide according to claim 1, wherein notes of a chord can be represented as circles, or any other shape.

9. The guide according to claim 1, wherein each column of three colored dots can be represented as a single dot divided into three equal parts matching said colors.

10. A method of teaching piano comprising the steps of: making a guide comprising a repeating pattern of colored dots printed on a strip of paper that can be placed along the keys of a keyboard instrument and slid sideways to highlight chords in all keys.

11. The method of claim 10, further comprising the steps of: constructing a pattern of shapes outlining the chord functions of the major scale.

12. The method of teaching piano using the guide of claim 1.
